(19) United States
(12) Patent Application Publication
(10) Pub. No.: US 2005/0287872 A1
(43) Pub. Date: Dec. 29, 2005

(54) Connector module

(76) Inventor: Pin-Hung Chen, Nepz Kaohsiung (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/878,520

(22) Filed: Jun. 29, 2004

(51) Int. Cl. H01R 24/00

(52) U.S. Cl. 439/676

(57) ABSTRACT

A connector module suitable for ultra-high speed network transmission is described. The connector module utilizes a network controlling interface device with substantially the same width as a socket of a jack. Electrical components with smaller size and better network transmission efficiency are disposed on the network controlling interface device. Therefore, the connector module has more compact package size, so as to reduce a package size of an electrical apparatus using the connector module and increase process yield and network transmission efficiency. In addition, at least one displaying device is disposed in the connector module and electrically connected to the network controlling interface device, so as to show a connection status of the network.

### FIELD OF THE INVENTION

The present invention relates to a connector module, and more particularly, to a connector module suitable for ultra-high speed network transmission.

### BACKGROUND OF THE INVENTION

With rapid development of information technology, more and more electrical and information products are available, and the computer system and its related peripheral industry make a further progress at a tremendous pace. The computers are very popular and the network technology is rapidly developed, so that the desired information can be obtained relatively fast through network and various information services can also be provided. The development in computers and network provides people with more convenient and comfortable environment.

Therefore, the current internet has been quickly progressing, and the network transmission technology has been also more and more advanced. Most of the network-connected computer equipments, need to use connectors for establishing connection to network or to other related electrical equipments such as hubs or the like.

Conventionally, a RJ-45 type connector, which is coupled by a jack and a plug, mostly serves as a connector of a computer used in the connection with network related equipments. In order to satisfy the requirement for ultra-high speed network transmission, a network card is configured with a RJ-45 type jack, a transformer, a controlling integrated circuit (IC) and an oscillator fixed on the printed circuit board (PCB). Reference is made to FIG. 1, which depicts a three-dimensional diagram of the network card in the prior art. The network card 100 in the prior art comprises a jack 101 and a network controlling interface device 110 electrically coupled thereof. The jack 101 is typically a RJ-45 type jack. The jack 101 is generally fixed on a supporter 103, so as to fix the jack 101 on a side of the network controlling interface device 110. The network controlling interface device 110 comprises a boxlike transformer 111, a peripheral component interconnect (PCI) 115 and an oscillator 117 disposed on a PCB 113. The boxlike transformer 111 is electrically coupled to the jack 101. The PCI 115, for supporting a 10/100 megabytes of Ethernet with high speed and a PCI integrated circuit (IC), is electrically coupled to the boxlike transformer 111. The oscillator 117 is electrically coupled to the PCI 115. Besides, a power supplying circuit 119 may be configured on the PCB 113, for supplying a direct current (DC) power required for related electrical devices on the network controlling interface device 110. Light emitting diodes (LEDs) 131 are further disposed on the supporter 103, so as to show a connecting status of the network. Output terminals 135 are disposed on another side of the network controlling interface device 110 to electrically couple to a motherboard (not shown).

When the jack 101 in the electrical equipment receives a signal from the network, the signal is transmitted to the boxlike transformer 111 through contact ramps (not shown) in the jack 101 and circuits on the PCB 113, then processed, received and sent by the PCI 115 and the oscillator 117.

However, as such for the network card 100 consisting of electrical components related to the jack 101 and the network controlling interface device 110, the related electrical components are larger in size, so that it is not avoidable for the electrical components to occupy a certain area of the PCB 113, resulting in a bottleneck of further reducing the package size of the electrical equipment. Furthermore, the electrical circuits used in the conventional network card 100 are more complicated, so that the yield of manufacturing process will be affected. Moreover, the related electrical components used in the conventional network card 100 and performance thereof cannot satisfy the requirement of the ultra-high speed network transmission.

Hence, for designers, custom user and manufacturers of equipments related to computers and network, there is an urgent need to further reduce the package size of the jack and the related electrical components with better network transmission performance

### SUMMARY OF THE INVENTION

It is an aspect of the present invention to provide a connector module suitable for ultra-high speed network transmission. A network controlling interface device is disposed in the connector module and has substantially the same width as a socket of a jack. Electrical components with smaller size and better network transmission efficiency are disposed on the network controlling interface device. Therefore, the connector module has more compact package size, so as to reduce a package size of an electrical apparatus using the connector module and increase process yield and network-transmission efficiency.

According to the aforementioned aspect of the present invention, there is provided a connector module, which comprises a housing, a jack and a network controlling interface device both received in the housing, wherein the network controlling interface device has substantially the same width as a socket of a jack. Electrical components with smaller size and better network transmission efficiency are disposed on the network controlling interface device. The housing comprises two spaces with openings. The jack is disposed in one space and is utilized for connecting with a network. The network controlling interface device is disposed in one another space, wherein the network controlling interface device is electrically coupled to the jack and has a boxlike transformer, a PCI, a memory, an oscillator and a power supplying device disposed on a PCB. The boxlike transformer is electrically coupled to the jack, the PCI is electrically coupled to the boxlike transformer, the memory and the oscillator are electrically coupled to the PCI respectively, and the power supplying device supplies a DC power required for the network controlling interface device. A displaying device is disposed at a corner of the one space of the housing and electrically coupled to the network controlling interface device, so as to show a connecting status of the network.

In a preferred embodiment, the jack may be a RJ-45 type jack.

In a preferred embodiment, the PCI may be supported for a 10/100/1000 megabytes of Ethernet with ultra-high speed and a PCI Express integrated circuit (IC).

In a preferred embodiment, the memory may be a programmable read-only memory (PROM), an erasable PROM (EPROM), or an electrically erasable PROM (EEPROM).

In a preferred embodiment, the openings of the housing are a front and rear openings. The housing is vertically divided into a first space and a second space via a first partition. The jack may be received in the first space, and the network controlling interface device may be horizontally received in the second space.

In one another preferred embodiment, the openings of the housing are a front and rear openings. The housing space is vertically divided into a front space and a rear space via a first partition. And, the front space is horizontally divided into an upper space and lower space via a second partition. The jack may be received in the upper space, and the network controlling interface device may be vertically received in the rear space.

The connector module has electrical components with smaller size and better network transmission efficiency disposed on the network controlling interface device, which has substantially the same width with one of a socket of a jack. Therefore, the connector module has more compact package size, so as to reduce a size of an electrical apparatus using the connector module and increase process yield and network-transmission efficiency.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a track of a spinneret on the basic fabric in the prior art;

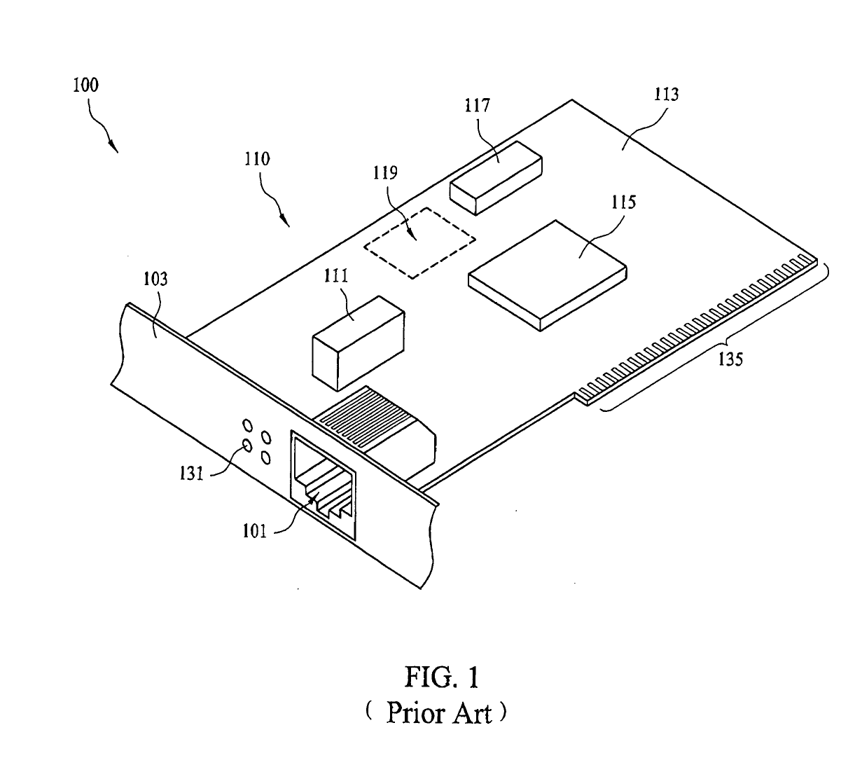

FIGS. 2(A) is a three-dimensional diagram of the connector module according to a preferred embodiment of the invention;

FIGS. 2(B) is a front view of the network controlling interface device according to a preferred embodiment of the invention;

FIG. 3 is an explored view of the connector module according to a preferred embodiment of the invention; and

FIG. 4 is an explored view of the connector module according to one another preferred embodiment of the invention.

### DETAILED DESCRIPTION OF THE PREFERRED EMBODIMENT

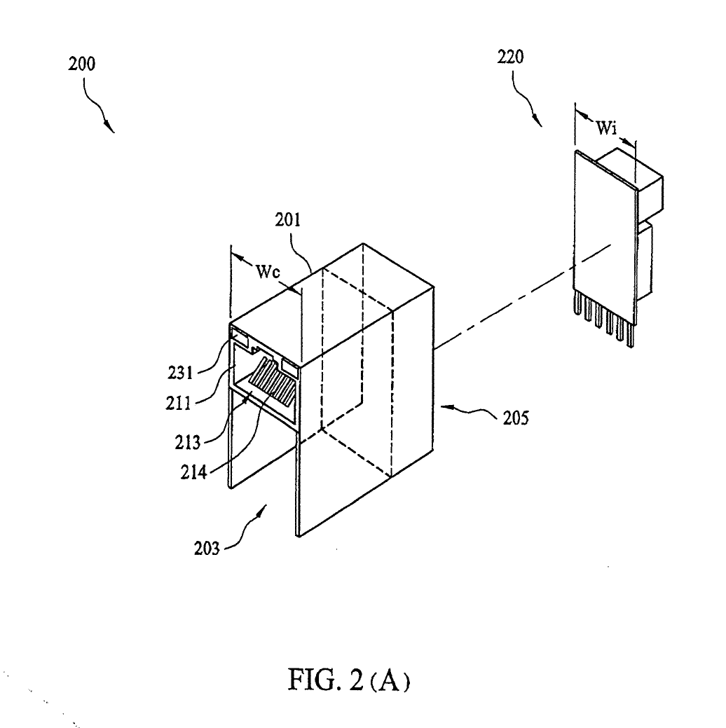

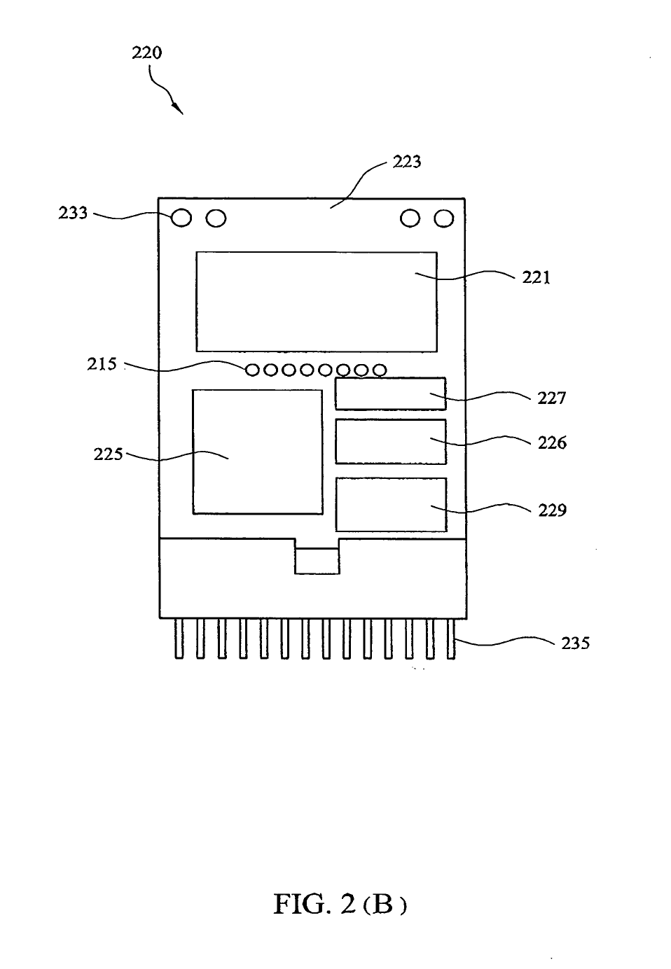

The connector module of the present invention has electrical components with smaller size and better network transmission efficiency disposed on the network controlling interface device, which has substantially the same width with one of a socket of a jack Therefore, the connector module has more compact package size, so as to reduce a package size of an electrical apparatus using the connector module and increase process yield and network-transmission efficiency. In order to describe the connector module of the present invention more explicitly and completely, the following description is stated with reference to FIGS. 2(A) to 4.

Reference is made to FIG. 2(A), which is a three-dimensional diagram of the connector module according to a preferred embodiment of the invention. In FIG. 2(A), the connector module 200, which is suitable for ultra-high speed network transmission, comprises a housing 201, a jack 211 and a network controlling interface device 220 both received in the housing 201, wherein the network controlling interface device 220 has substantially the same width Wi with a width Wc of a socket 213 of the jack 211. The jack 211, which is typically provided for ultra-high speed network transmission, may be a RJ-45 type jack, and contact ramps 214 are disposed therein

Reference is made to FIG. 2(B), which is a front view of the network controlling interface device according to a preferred embodiment of the invention. In FIG. 2(B), the network controlling interface device 220 comprises a boxlike former 221, a PCI 225, a memory 226, an oscillator 227 and a power supplying device 229 disposed on a PCB 223. The boxlike transformer 221 such as a pulse transformer, is electrically coupled to the jack 211. The PCI 225, for supporting a 10/100/1000 megabytes of Ethernet with ultra-high speed and a PCI Express integrated circuit (IC), is electrically coupled to the boxlike transformer 221 by inner terminal pins 215, for example. The memory 226 is electrically coupled to the PCI 225, which may be a PROM, an EPROM or an EEPROM. However, the EEPROM is preferred. The oscillator 227, such as a quartz oscillator, is electrically coupled to the PCI 225. The power supplying device 229 may supply a DC power required for related electrical devices on the network controlling interface device 220.

In a preferred embodiment of the present invention, the power supplying device 229 may be a boxlike the power module, and the oscillator 227 and the power supplying device 229 are disposed on the PCB 223. However, in an another preferred embodiment of the present invention, other power supplying ways in the prior art, such as a conventional power supplying circuit may also serve as the power supplying device 229, and the oscillator 227 and the power supplying device 229 are further on one another PCB, wherein such PCB may be a little smaller than or equal to the PCB 223 in size, and be disposed in the same space with the network controlling interface device 220 together, for supplying a DC power required for related electrical devices on the network controlling interface device 220. However, as is understood by a person skilled in the art, the foregoing power supplying ways are merely illustrated exemplarily rather than limiting the spirit and the scope of the related electrical devices on the network controlling interface device 220.

Reference is made to FIG. 2(A) again the connector module 200 of the present invention further utilizes at least one displaying device 231 electrically coupled, for example, to contacts 233 on the network controlling interface device 220, so as to show a connecting status of the network. The displaying device 231 may be an LED. In addition, the network controlling interface device 220 of the present invention further utilizes inner terminal pins 215 on the PCB 223 electrically coupled to the jack 211, and outer terminal pins 235 electrically coupled to a motherboard (not shown).

Comparison with conventional electrical components employed in the prior network interface card, the network controlling interface device 220 of the present invention is characterized by electrical components with smaller size and better network transmission efficiency, such as the boxlike transformer 221, the smaller PCI 225 and the smaller memory 226. Therefore, that simplifies a design of the circuit layout Furthermore, the width Wi of the network controlling interface device 220 is substantially the same as the width Wc of the socket 213 of the jack 211, so as to make the connector module 200 more compact in the package size. Moreover, comparison with the required power of the prior network interface card necessarily supplied by the motherboard, the network controlling interface device 220 of the present invention can provide faster speed network transmission as a result of the independent power supplying device 229. In addition, the network controlling interface device 220 of the present invention has the memory 226 disposed thereon to access data, for satisfying the requirement of ultra-high speed network transmission. Besides, the connector module 200 of the present invention has at least one displaying device 231 disposed thereon, so as to show a connecting status of the network clearly. When the jack 211 in the electrical equipment receives a signal from the network, the signal is transmitted to the boxlike transformer 221 through contact ramps 214 in the jack 211 and inner terminal pins 215, then processed, received and sent by the PCI 225, the memory 226 and the oscillator 227.

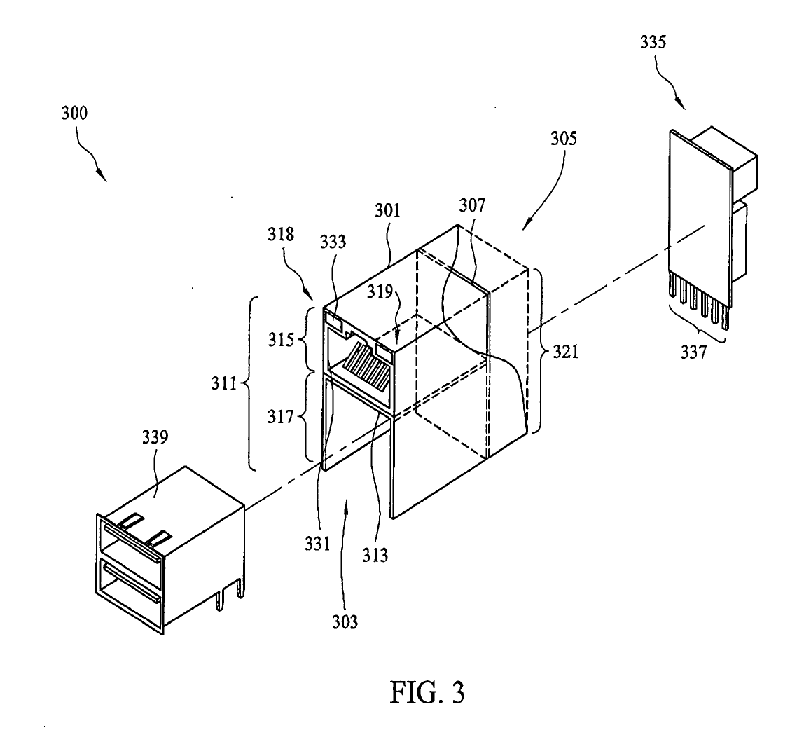

It is worthy to mention that, the connector module of the present invention is further characterized by the network controlling interface device with substantially the same width as the socket of the jack. Hence, the connector module has more compact package size, so as to reduce a size of an electrical apparatus using the connector module. In a preferred embodiment of the present invention, the network controlling interface device is received in the housing with respect to the socket of the jack in a parallel direction, for being disposed in a common electrical equipment. Reference is made to FIG. 3, which is an explored view of the connector module according to a preferred embodiment of the invention. The housing 301 of the connector module 300 has a front opening 303 and a rear opening 305, wherein the housing 301 is vertically divided into a front space 311 and a rear space 321 via a partition 307, and the front space 311 is horizontally divided into an upper space 315 and lower space 317 via a partition 313. The jack 331 may be received in the upper space 315, a displaying device 333 may be disposed at a corner 318 and/or a corner 319 of the upper space 315, and the network controlling interface device 335 may be vertically disposed in the rear space 321. Outer terminal pins 337 are disposed on a bottom side of the network controlling interface device 335 near to the opening 305, for electrically coupling the network controlling interface device 335 and a motherboard (not shown) together. The housing 301, the partition 307, the partition 313 and the jack 331 used in this embodiment can be made in a whole or be assembled, but rather than being limited by the disclosure as above. Furthermore, at least one universal serial bus (USB) connecting device may be optionally received in the lower space 317.

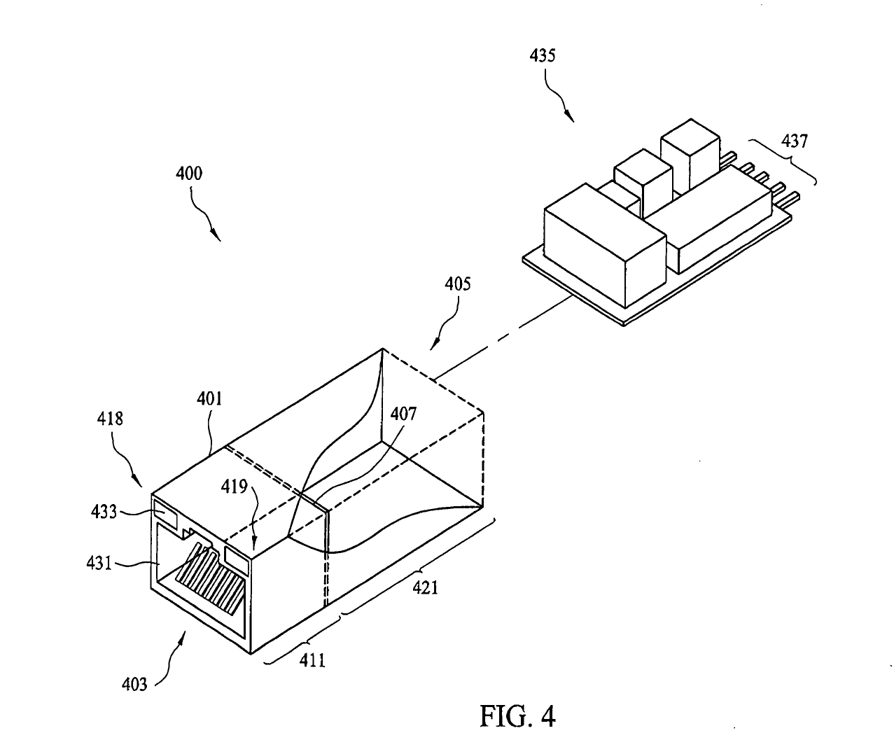

In one another preferred embodiment, the network controlling interface device is received in the housing with respect to the socket of the jack in a vertical direction, for being disposed in a thinner or portable electrical equipment. Reference is made to FIG. 4, which is an explored view of the connector module according to one another preferred embodiment of the invention. The housing 401 of the connector module 400 has a front opening 403 and a rear opening 405, wherein the housing 401 is vertically divided into a first space 411 and a second space 421 via a partition 407. The jack 431 may be received in the first space 411, a displaying device 433 may be disposed at a corner 418 and/or a corner 419 of the first space 411, and the network controlling interface device 435 may be horizontally disposed in the second space 421. Outer terminal pins 435 are disposed on a bottom side of the network controlling interface device 435 near to the opening 405, for electrically coupling the network controlling interface device 435 and a motherboard (not shown) together. The housing 401, the partition 407 and the jack 431 used in this embodiment can be made in a whole or be assembled, but rather than being limited by the disclosure as above.

In other preferred embodiment, the network controlling interface device is also received in the housing with respect to the socket of the jack in a tilt angle, for being disposed in an electrical equipment with particular specification. However, as is understood by a person skilled in the art, the tilt angle depends on a inner configuration of the electrical equipment where the connector module of the present invention is disposed, but rather than limiting the spirit and the scope of the tilt angle.

Therefore, according to the aforementioned preferred embodiments, one advantage of the connector module is utilized a electrical components with smaller size and better network transmission efficiency disposed on the network controlling interface device, which has substantially the same width with one of a socket of a jack. Therefore, the connector module has more compact package size, so as to reduce a size of an electrical apparatus using the connector module and increase process yield and network-transmission efficiency. In addition, at least one displaying device is disposed in the connector module and electrically connected to the network controlling interface device, so as to show a connection status of the network.

As is understood by a person skilled in the art, the foregoing preferred embodiments of the present invention are illustrated of the present invention rather than limiting of the present invention. It is intended to cover various modifications and similar arrangements included within the spirit and scope of the appended claims. Therefore, the scope of which should be accorded the broadest interpretation so as to encompass all such modifications and similar structure.

1. A connector module, suitable for ultra-high speed network transmission, the connector module comprising:
a housing having a first space and a second space with openings;
a jack received in the first space, wherein the jack is used for connecting with a network;
a network controlling interface device which is received in the second space and is electrically coupled to the jack, wherein the network controlling interface device comprises:
a boxlike transformer which is disposed on a printed circuit board (PCB) and is electrically coupled to the jack;
a peripheral component interconnect (PCI) which is disposed on the PCB and is electrically coupled to the boxlike transformer;
a memory which is disposed on the PCB and is electrically coupled to the PCI;
an oscillator electrically coupled to the PCI; and
a power supplying device used for supplying a DC power required for the network controlling interface device; and
at least one displaying device which is disposed at a corner of the first space and is electrically coupled to the network controlling interface device, so as to show a connecting status of the network,
wherein the network controlling interface device has substantially the same width as a socket of the jack, so as to reduce a size of the connector module.

2. The connector module according to claim 1, wherein the jack is a RJ-45 type jack.

3. The connector module according to claim 1, wherein the PCI is utilized for supporting a 10/100/1000 megabytes of Ethernet with ultra-high speed and a PCI Express integrated circuit (IC).

4. The connector module according to claim 1, wherein the memory is selected from the group consisting of a programmable read-only memory (PROM), an erasable PROM (EPROM) and an electrically erasable PROM (EEPROM).

5. The connector module according to claim 1, wherein outer terminal pins are disposed near the opening of the second space for electrically coupling the network controlling interface device and a motherboard together.

6. The connector module according to claim 1, wherein the displaying device is a light emitting diode (LED).

7. The connector module according to claim 1, wherein the network controlling interface device is parallel to a surface of the socket of the jack, and is horizontally received in the second space.

8. The connector module according to claim 1, wherein the network controlling interface device is vertical to a surface of the socket of the jack, and is received in the second space.

9. The connector module according to claim 1, wherein the network controlling interface device tilts a tilt angle with respect to a surface of the socket of the jack, and is received in the second space.

10. The connector module according to claim 1, wherein the power supplying device is a boxlike power module, and the oscillator and the power supplying device are disposed on the PCB.

11. The connector module according to claim 1, wherein the power supplying device is a power supplying circuit, and the oscillator and the power supplying device are disposed on another PCB, and the another PCB is received in the second space.

12. A network controlling interface device, suitable for ultra-high speed network transmission, the network controlling interface device comprises:
a boxlike transformer which is disposed on a PCB and is electrically coupled to a RJ-45 type jack;
a PCI which is disposed on the PCB and is electrically coupled to the boxlike transformer;
a memory which is disposed on the PCB and is electrically coupled to the PCI;
an oscillator electrically coupled to the PCI; and
a power supplying device used for supplying a DC power required for the network controlling interface device;
wherein the network controlling interface device has substantially the same width as a socket of the RJ-45 type jack, and the network controlling interface device is further electrically coupled to at least one displaying device for showing a connecting status of the network.

13. The network controlling interface device according to claim 12, wherein the PCI is utilized for supporting a 10/100/1000 megabytes of Ethernet with ultra-high speed and a PCI Express IC.

14. The network controlling interface device according to claim 12, wherein the memory is selected from the soup consisting of a PROM, an EPROM and an EEPROM.

15. The network controlling interface device according to claim 12, wherein outer terminal pins are disposed on a side of the network controlling interface device for electrically coupling the network controlling interface device and a motherboard together.

16. The network controlling interface device according to claim 12, wherein the displaying device is a LED.

17. The network controlling interface device according to claim 12, wherein the power supplying device is a boxlike power module, and the oscillator and the power supplying device are disposed on the PCB.

18. The network controlling interface device according to claim 12, wherein the network controlling interface device and the RJ-45 type jack are disposed in a housing that has a front opening and a rear opening and is vertically divided into a first space and a second space via a first partition, and wherein the RJ-45 type jack is received in the first space and the network controlling interface device is received in the second space.

19. The network controlling interface device according to claim 18, wherein the power supplying device is a power supplying circuit, and the oscillator and the power supplying device are disposed on another PCB, and the another PCB is received in the second space.

20. The network controlling interface device according to claim 12, wherein the network controlling interface device and the RJ-45 type jack are disposed in a housing that has a front opening and a rear opening and is vertically divided into a front space and a rear space via a first partition, and the front space is horizontally divided into an upper space and a lower space via a second partition, and the RJ-45 type jack is received in the upper space and the network controlling interface device is vertically received in the rear space.

21. The network controlling interface device according to claim 20, wherein the power supplying device is a power supplying circuit, and the oscillator and the power supplying device are disposed on another PCB, and the another PCB is received in the rear space.

22. The network controlling interface device according to claim 20, wherein at least one USB connecting device is received in the lower space.
